(19) United States
(12) Patent Application Publication
(10) Pub. No.: US 2024/0396853 A1
(43) Pub. Date: Nov. 28, 2024

(54) NETWORK-CONTROLLED APPLICABILITY OF ROUTING PARAMETERS

(71) Applicant: Nokia Technologies Oy, Espoo (FI)

(72) Inventors: Lazaros GKATZIKIS, Massy (FR); Laurent THIÉBAUT, Massy (FR)

(21) Appl. No.: 18/689,714

(22) PCT Filed: Jun. 14, 2022
(86) PCT No.: PCT/EP2022/066083

§ 371 Date: Mar. 6, 2024

Related U.S. Application Data
(60) Provisional application No. 63/241,034, filed on Sep. 6, 2021.

(51) Int. Cl. H04L 49/253; H04L 45/302; H04L 65/1069

(52) U.S. Cl. CPC H04L 49/253; H04L 45/306; H04L 65/1069

(57) ABSTRACT

Method, apparatuses, and computer program products provide means for indicating and evaluating EPS network applicability of 5GS UE Route Selection Policy parameters. An example method for evaluation of applicability of parameters includes receiving a policy rule data object comprising a plurality of rule descriptors each comprising parameters associated with respective network applicability indications. The method further includes, upon entering a rule evaluation state: determining whether a rule descriptor satisfies first conditions from the respective network applicability indications associated with the parameters of the rule descriptor, and in an instance in which the rule descriptor is determined to satisfy the first conditions, identifying a respective parameter of the rule descriptor as satisfying second conditions from an associated respective network applicability indication. The method further includes causing a network connection to be established using rule descriptors determined to satisfy the first conditions and parameters thereof identified to satisfy the second conditions.

### CROSS-REFERENCE TO RELATED APPLICATIONS

This application claims the benefit of U.S. Provisional Application No. 63/241,034, filed Sep. 6, 2021, the entire contents of which are incorporated herein by reference.

### TECHNOLOGICAL FIELD

An example embodiment relates generally to techniques for configuring, indicating, and/or evaluating applicability of routing parameters for various different networks.

### BACKGROUND

Various networks can be configured to interwork and interoperate with other networks. For example, interworking and interoperability with Long-Term Evolution (LTE) Evolved Packet System (EPS) has been provisioned and configured for a 5G System (5GS). With interoperability between 5GS and EPS, a user equipment (UE) can be configured to communicate via 5GS or EPS. Connection with and communication via different networks (e.g., 5GS, EPS) may involve different parameters, including parameters for UE route selection policies (e.g., routing parameters), which can define different UE behavior depending on the network. While UE route selection policies (URSPs) are defined in context of 5GS networks and are supported by 5GS networks, various parameters of a URSP may not be clearly mapped or exactly applicable when used for connecting to and communicating via EPS networks. Thus, a UE must be able to evaluate various parameters in an appropriate network context, such that network sessions and connections with a particular network can be properly established.

### BRIEF SUMMARY

Various embodiments generally relate to applicability of routing parameters, such as URSP parameters, for various different networks. In particular, various embodiments of the present disclosure provide methods, systems, computer program products, apparatuses, devices, and/or the like for configuring, indicating, and/or evaluating an applicability of routing parameters, such as URSP parameters, that are defined and provisioned in a first type of network. Specifically, the first type of network is a native network for the UE, such as a 5GS network. Specifically, applicability of said routing parameters to a second type of network is configured, indicated, and/or evaluated, and the second type of network is specifically a non-native network for the UE, such as an EPS network. In various embodiments, such applicability for a parameter is encoded via a network applicability indication associated with and corresponding to the parameter.

A policy rule data object that encodes, defines, describes, and/or the like a URSP comprises a plurality of rule descriptors and includes network applicability indications for the parameters of the plurality of rule descriptors. A rule descriptor can be a traffic descriptor of the URSP or a route selection descriptor of the URSP. In any regard, the applicability of a parameter of a rule descriptor of a policy rule data object to a particular network is described by a respective network applicability indication. For example, the URSP and parameters thereof are defined in the context of 5GS (a native network for the UE), and a network applicability indication describes the applicability of a respective parameter to EPS (a non-native network for the UE). Continuing in the example, a UE may then evaluate the network applicability indications of parameters of one or more URSPs when connecting to and communicating via EPS.

Various embodiments then provide various technical advantages that include improved efficiency in the communication, provisioning, and evaluation of URSPs. The inclusion of network applicability indications in a policy rule data object for a URSP precludes a need to separately design and signal specific route selection policy variants for each different network. Various embodiments additionally enable a variable amount of applicable information to be used when communicating via different networks, as applicability is described on at least a parameter-level as opposed to a URSP-level, thereby enabling a UE to use as much applicable information as possible when communicating via a different type of network, or a non-native network (e.g., EPS).

According to one aspect of the present disclosure, an apparatus is provided. The apparatus includes at least one processor and at least one memory including computer program code. The at least one memory and the computer program code are configured to, with the at least one processor, cause the apparatus to receive a policy rule data object including a plurality of rule descriptors. A rule descriptor of the plurality of rule descriptors includes a plurality of parameters associated with respective network applicability indications. The at least one memory and the computer program code are further configured to, with the at least one processor, cause the apparatus to, upon entering a rule evaluation state over a non-native network: determine whether the rule descriptor of the plurality of rule descriptors satisfies one or more first conditions based at least in part on the respective network applicability indications associated with the parameters of the rule descriptor, in an instance in which the rule descriptor is determined to satisfy the one or more first conditions, identify a respective parameter of the rule descriptor as satisfying one or more second conditions based at least in part on the respective network applicability indication associated with the respective parameter, and cause a network connection to be established or cause an established network connection to be used using a subset of the plurality of rule descriptors of the policy rule data object that are determined to satisfy the one or more first conditions and using one or more parameters of the rule descriptors of the subset that are identified as satisfying the one or more second conditions.

In various embodiments, the policy rule data object is received subsequent to transmission, by the apparatus, of a compatibility support indication in an initial signaling exchange. In various embodiments, the at least one memory and the computer program code are further configured to, with the at least one processor, cause the apparatus to determine the rule descriptor to not satisfy one or more first conditions in an instance in which at least one parameter of the rule descriptor is associated with a first network applicability indication value. In various embodiments, the at least one memory and the computer program code are further configured to, with the at least one processor, cause the apparatus to identify the respective parameter as not satisfying the one or more second conditions in an instance in which the respective parameter is associated with a second network applicability indication value and to identify the respective parameter as satisfying the one or more second conditions in an instance in which the respective parameter is associated with a third network applicability indication value.

In various embodiments, the at least one memory and the computer program code are further configured to, with the at least one processor, cause the apparatus to receive a policy rule data object comprising a plurality of rule descriptors and one or more higher-precedence rule descriptors corresponding to one or more of the plurality of rule descriptors. In various embodiments, the one or more of the plurality of rule descriptors include at least one of a pre-determined set of non-applicable parameters. In various embodiments, the plurality of parameters of the rule descriptor of the policy rule data object define a network connection with a native network, and wherein the network applicability indication of a respective parameter of the plurality of parameters describes an applicability of the rule descriptor and/or the respective parameter to the non-native network. In various embodiments, the network connection that is caused to be established or that is caused to be used is with the non-native network.

In various embodiments, at least a first parameter associated with a respective network applicability indication describes one or more locations at which the apparatus is enabled to establish and/or use a network connection and at least a second parameter associated with a respective network applicability indication describes a time window within which the apparatus is enabled to establish and/or use a network connection. In various embodiments, the plurality of rule descriptors includes at least a first rule descriptor that is a traffic descriptor and one or more second rule descriptors that are route selection descriptors. In various embodiments, the subset of the plurality of rule descriptors includes one or more route selection descriptors that are determined to independently satisfy the one or more first conditions.

In various embodiments, the policy rule data object is received over a native network, and the non-native network is different from the native network. In various embodiments, the native network includes a 5th-Generation System (5GS) network, and the non-native network includes an Evolved Packet System (EPS) network

According to another aspect of the present disclosure, another apparatus is provided. The apparatus includes at least one processor and at least one memory including computer program code. The at least one memory and the computer program code are configured to, with the at least one processor, cause the apparatus to receive a compatibility support indication associated with a user equipment (UE). The at least one memory and the computer program code are further configured to, with the at least one processor, cause the apparatus to, for a policy rule data object including a plurality of rule descriptors, a rule descriptor of the plurality of rule descriptors including a plurality of parameters, generate a network applicability indication for a respective parameter of the plurality of parameters based at least in part on the computability support indication. The at least one memory and the computer program code are further configured to cause transmission of the one or more policy rule data objects with the network applicability indication for the respective parameter of the plurality of parameters to the UE, and receive an acknowledgement of the one or more policy rule data objects and the network applicability indication for the respective parameter originating from the UE.

In various embodiments, generating the network applicability indication for the respective parameter of a rule descriptor includes determining an applicability of the rule descriptor and/or the respective parameter to a non-native network for the UE, the respective parameter defining a network connection with a native network for the UE, and generating one of a first network applicability indication value, a second network applicability indication value, or a third network applicability indication value based at least in part on the determined applicability. In various embodiments, the native network for the UE includes a 5th Generation System (5GS) network, and the non-native network includes an Evolved Packet System (EPS) network. In various embodiments, the first network applicability indication value is configured to cause the rule descriptor including the respective parameter associated with the first network applicability indication value to not satisfy one or more first conditions, the second network applicability indication value is configured to cause the respective parameter associated with the second network applicability indication value to not satisfy one or more second conditions, and the third network applicability indication value is configured to cause the respective parameter associated with the third network applicability indication value to satisfy the one or more second conditions.

In various embodiments, the at least one memory and the computer program code are further configured to, with the at least one processor, cause the apparatus to, responsive to the compatibility support indication indicating that the UE is not configured for a non-native network: identify one or more of the plurality of rule descriptors that include at least one of a pre-determined set of non-applicable parameters, and generate a higher-precedence rule descriptor corresponding to a respective rule descriptor of the identified one or more rule descriptors.

In various embodiments, at least a first parameter associated with a respective network applicability indication describes one or more locations at which the UE is enabled to establish and/or use a network connection and at least a second parameter associated with a respective network applicability indication describes a time window within which the UE is enabled to establish and/or use a network connection. In various embodiments, the plurality of rule descriptors includes at least a first rule descriptor that is a traffic descriptor and one or more second rule descriptors that are route selection descriptors. In various embodiments, the plurality of rule descriptors are configured to be independently evaluated by the UE as to whether one or more first conditions are satisfied. In various embodiments, the apparatus is a network device of a native network for the UE, and the transmission of the one or more policy rule data objects to the UE is over the native network for the UE.

According to yet another aspect of the present disclosure, a computer-implemented method is provided. The method includes receiving a policy rule data object including a plurality of rule descriptors. A rule descriptor of the plurality of rule descriptors includes a plurality of parameters associated with respective network applicability indications. The method further includes, upon entering a rule evaluation state over a non-native network: determining whether the rule descriptor of the plurality of rule descriptors satisfies one or more first conditions based at least in part on the respective network applicability indications associated with the parameters of the rule descriptor, in an instance in which the rule descriptor is determined to satisfy the one or more first conditions, identifying a respective parameter of the rule descriptor as satisfying one or more second conditions based at least in part on the respective network applicability indication associated with the respective parameter, and causing a network connection to be established or causing an established network connection to be used, using a subset of the plurality of rule descriptors of the policy rule data object that are determined to satisfy the one or more first conditions and using one or more parameters of the rule descriptors of the subset that are identified as satisfying the one or more second conditions.

In various embodiments, the policy rule data object is received subsequent to transmission of a compatibility support indication in an initial signaling exchange. In various embodiments, the rule descriptor is determined to not satisfy the one or more first conditions in an instance in which at least one parameter of the rule descriptor is associated with a first network applicability indication value. In various embodiments, the respective parameter is identified as not satisfying the one or more second conditions in an instance in which the respective parameter is associated with a second network applicability indication value, and wherein the respective parameter is identified as satisfying the one or more second conditions in an instance in which the respective parameter is associated with a third network applicability indication value.

In various embodiments, the method further includes receiving a policy rule data object including a plurality of rule descriptors and one or more higher-precedence rule descriptors corresponding to one or more of the plurality of rule descriptors. In various embodiments, the one or more of the plurality of rule descriptors include at least one of a pre-determined set of non-applicable parameters. In various embodiments, the plurality of parameters of the rule descriptor of the policy rule data object define a network connection with a native network. The network applicability indication of a respective parameter of the plurality of parameters describes an applicability of the rule descriptor and/or the respective parameter to non-native network. In various embodiments, the network connection that is caused to be established or that is caused to be used is with the non-native network.

In various embodiments, at least a first parameter associated with a respective network applicability indication describes one or more locations at which the apparatus is enabled to establish and/or use a network connection and at least a second parameter associated with a respective network applicability indication describes a time window within which the apparatus is enabled to establish and/or use a network connection. In various embodiments, the plurality of rule descriptors includes at least a first rule descriptor that is a traffic descriptor and one or more second rule descriptors that are route selection descriptors. In various embodiments, the subset of the plurality of rule descriptors includes one or more route selection descriptors that are determined to independently satisfy the one or more first conditions.

In various embodiments, the policy rule data object is received over a native network, and the non-native network is different from the native network. In various embodiments, the native network includes a 5th-Generation System (5GS) network, and the non-native network includes an Evolved Packet System (EPS) network.

According to yet another aspect of the present disclosure, a computer-implemented method is provided. The method includes receiving a compatibility support indication associated with a user equipment (UE). The method further includes, for a policy rule data object including a plurality of rule descriptors, a rule descriptor of the plurality of rule descriptors including a plurality of parameters, generating a network applicability indication for a respective parameter of the plurality of parameters based at least in part on the computability support indication. The method further includes causing transmission of the one or more policy rule data objects with the network applicability indication for the respective parameter of the plurality of parameters to the UE, and receiving an acknowledgement of the one or more policy rule data objects and the network applicability indication for the respective parameter originating from the UE.

In various embodiments, generating the network applicability indication for the respective parameter of a rule descriptor includes determining an applicability of the rule descriptor and/or the respective parameter to a non-native network for the UE, the respective parameter defining a network connection with a native network for the UE, and generating one of a first network applicability indication value, a second network applicability indication value, or a third network applicability indication value based at least in part on the determined applicability. In various embodiments, the native network for the UE includes a 5th Generation System (5GS) network, and the non-native network includes an Evolved Packet System (EPS) network. In various embodiments, the first network applicability indication value is configured to cause the rule descriptor including the respective parameter associated with the first network applicability indication value to not satisfy one or more first conditions, the second network applicability indication value is configured to cause the respective parameter associated with the second network applicability indication value to not satisfy one or more second conditions, and the third network applicability indication value is configured to cause the respective parameter associated with the third network applicability indication value to satisfy the one or more second conditions.

In various embodiments, the method further includes, responsive to the compatibility support indication indicating that the UE is not configured for a non-native network: identifying one or more of the plurality of rule descriptors that include at least one of a pre-determined set of non-applicable parameters, and generating a higher-precedence rule descriptor corresponding to a respective rule descriptor of the identified one or more rule descriptors.

In various embodiments, at least a first parameter associated with a respective network applicability indication describes one or more locations at which the UE is enabled to establish and/or use a network connection and at least a second parameter associated with a respective network applicability indication describes a time window within which the UE is enabled to establish and/or use a network connection. In various embodiments, the plurality of rule descriptors includes at least a first rule descriptor that is a traffic descriptor and one or more second rule descriptors that are route selection descriptors. In various embodiments, the plurality of rule descriptors are configured to be independently evaluated by the UE as to whether one or more first conditions are satisfied. In various embodiments, the transmission of the one or more policy rule data objects to the UE is over a native network for the UE.

According to yet another aspect of a present disclosure, a computer program product is provided. The computer program product includes at least one non-transitory computer readable storage medium having computer executable program code instructions stored therein. The computer executable program code instructions include program code instructions configured, upon execution, to receive a policy rule data object comprising a plurality of rule descriptors. A rule descriptor of the plurality of rule descriptors includes a plurality of parameters associated with respective network applicability indications. The computer executable program code instructions include program code instructions further configured, upon execution, to, upon entering a rule evaluation state over a non-native network: determine whether the rule descriptor of the plurality of rule descriptors satisfies one or more first conditions based at least in part on the respective network applicability indications associated with the parameters of the rule descriptor, in an instance in which the rule descriptor is determined to satisfy the one or more first conditions, identify a respective parameter of the rule descriptor as satisfying one or more second conditions based at least in part on the respective network applicability indication associated with the respective parameter, and cause a network connection to be established or an established network connection to be used, using a subset of the plurality of rule descriptors of the policy rule data object that are determined to satisfy the one or more first conditions and using one or more parameters of the rule descriptors of the subset that are identified as satisfying the one or more second conditions.

In various embodiments, the policy rule data object is received subsequent to transmission of a compatibility support indication in an initial signaling exchange. In various embodiments, the rule descriptor is determined to not satisfy the one or more first conditions in an instance in which at least one parameter of the rule descriptor is associated with a first network applicability indication value. In various embodiments, the respective parameter is identified as not satisfying the one or more second conditions in an instance in which the respective parameter is associated with a second network applicability indication value, and wherein the respective parameter is identified as satisfying the one or more second conditions in an instance in which the respective parameter is associated with a third network applicability indication value.

In various embodiments, the computer executable program code instruction include program code instructions further configured, upon execution, to receive a policy rule data object comprising a plurality of rule descriptors and one or more higher-precedence rule descriptors corresponding to one or more of the plurality of rule descriptors. In various embodiments, the one or more of the plurality of rule descriptors include at least one of a pre-determined set of non-applicable parameters. In various embodiments, the plurality of parameters of the rule descriptor of the policy rule data object define a network connection with a native network, and the network applicability indication of a respective parameter of the plurality of parameters describes an applicability of the rule descriptor and/or the respective parameter to the non-native network. In various embodiments, the network connection that is caused to be established or that is caused to be used is with the non-native network.

In various embodiments, at least a first parameter associated with a respective network applicability indication describes one or more locations at which the apparatus is enabled to establish and/or use a network connection and at least a second parameter associated with a respective network applicability indication describes a time window within which the apparatus is enabled to establish and/or use a network connection. In various embodiments, the plurality of rule descriptors includes at least a first rule descriptor that is a traffic descriptor and one or more second rule descriptors that are route selection descriptors. In various embodiments, the subset of the plurality of rule descriptors includes one or more route selection descriptors that are determined to independently satisfy the one or more first conditions. In various embodiments, the policy rule data object is received over a native network, and the non-native network is different from the native network. In various embodiments, the native network includes a 5th Generation System (5GS) network, and wherein the non-native network includes an Evolved Packet System (EPS) network.

According to yet another aspect of a present disclosure, another computer program product is provided. The computer program product includes at least one non-transitory computer readable storage medium having computer executable program code instructions stored therein. The computer executable program code instructions include program code instructions configured, upon execution, to receive a compatibility support indication associated with a user equipment (UE). The computer executable program code instructions include program code instructions further configured, upon execution, to, for a policy rule data object including a plurality of rule descriptors, a rule descriptor of the plurality of rule descriptors including a plurality of parameters, generate a network applicability indication for a respective parameter of the plurality of parameters based at least in part on the computability support indication. The computer executable program code instructions include program code instructions configured, upon execution, to cause transmission of the one or more policy rule data objects with the network applicability indication for the respective parameter of the plurality of parameters to the UE, and receive an acknowledgement of the one or more policy rule data objects and the network applicability indication for the respective parameter originating from the UE.

In various embodiments, generating the network applicability indication for the respective parameter of a rule descriptor includes determining an applicability of the rule descriptor and/or the respective parameter to a non-native network for the UE, the respective parameter defining a network connection with a native network for the UE, and generating one of a first network applicability indication value, a second network applicability indication value, or a third network applicability indication value based at least in part on the determined applicability. In various embodiments, the native network for the UE includes a 5th Generation System (5GS) network, and the non-native network includes an Evolved Packet System (EPS) network. In various embodiments, the first network applicability indication value is configured to cause the rule descriptor comprising the respective parameter associated with the first network applicability indication value to not satisfy one or more first conditions, the second network applicability indication value is configured to cause the respective parameter associated with the second network applicability indication value to not satisfy one or more second conditions, and the third network applicability indication value is configured to cause the respective parameter associated with the third network applicability indication value to satisfy the one or more second conditions.

In various embodiments, the computer executable program code instructions include program code instructions further configured, upon execution, to, responsive to the compatibility support indication indicating that the UE is not configured for a non-native network: identify one or more of the plurality of rule descriptors that include at least one of a pre-determined set of non-applicable parameters, and generate a higher-precedence rule descriptor corresponding to a respective rule descriptor of the identified one or more rule descriptors.

In various embodiments, at least a first parameter associated with a respective network applicability indication describes one or more locations at which the UE is enabled to establish and/or use a network connection and at least a second parameter associated with a respective network applicability indication describes a time window within which the UE is enabled to establish and/or use a network connection. In various embodiments, the plurality of rule descriptors includes at least a first rule descriptor that is a traffic descriptor and one or more second rule descriptors that are route selection descriptors. In various embodiments, the plurality of rule descriptors are configured to be independently evaluated by the UE as to whether one or more first conditions are satisfied. In various embodiments, the transmission of the one or more policy rule data objects to the UE is over a native network for the UE.

According to another aspect of the present disclosure, an apparatus is provided. The apparatus includes means for receiving a policy rule data object comprising a plurality of rule descriptors. A rule descriptor of the plurality of rule descriptors includes a plurality of parameters associated with respective network applicability indications. The apparatus further includes means for determining whether the rule descriptor of the plurality of rule descriptors satisfies one or more first conditions based at least in part on the respective network applicability indications associated with the parameters of the rule descriptor, upon entering a rule evaluation state over a non-native network. The apparatus further includes means for, also upon entering a rule evaluation state and in an instance in which the rule descriptor is determined to satisfy the one or more first conditions, identify a respective parameter of the rule descriptor as satisfying one or more second conditions based at least in part on the respective network applicability indication associated with the respective parameter. The apparatus further includes means for cause a network connection to be established or an established network connection to be used, using a subset of the plurality of rule descriptors of the policy rule data object that are determined to satisfy the one or more first conditions and using one or more parameters of the rule descriptors of the subset that are identified as satisfying the one or more second conditions.

In various embodiments, the policy rule data object is received subsequent to transmission of a compatibility support indication in an initial signaling exchange. In various embodiments, the rule descriptor is determined to not satisfy the one or more first conditions in an instance in which at least one parameter of the rule descriptor is associated with a first network applicability indication value. In various embodiments, the respective parameter is identified as not satisfying the one or more second conditions in an instance in which the respective parameter is associated with a second network applicability indication value, and the respective parameter is identified as satisfying the one or more second conditions in an instance in which the respective parameter is associated with a third network applicability indication value.

In various embodiments, the apparatus includes means for receiving a policy rule data object comprising a plurality of rule descriptors and one or more higher-precedence rule descriptors corresponding to one or more of the plurality of rule descriptors. In various embodiments, the one or more of the plurality of rule descriptors include at least one of a pre-determined set of non-applicable parameters. In various embodiments, the plurality of parameters of the rule descriptor of the policy rule data object define a network connection with a native network, and the network applicability indication of a respective parameter of the plurality of parameters describes an applicability of the rule descriptor and/or the respective parameter to the non-native network. In various embodiments, the network connection that is caused to be established or that is caused to be used is with the non-native network.

In various embodiments, at least a first parameter associated with a respective network applicability indication describes one or more locations at which the apparatus is enabled to establish and/or use a network connection and at least a second parameter associated with a respective network applicability indication describes a time window within which the apparatus is enabled to establish and/or use a network connection. In various embodiments, the plurality of rule descriptors includes at least a first rule descriptor that is a traffic descriptor and one or more second rule descriptors that are route selection descriptors. In various embodiments, the subset of the plurality of rule descriptors includes one or more route selection descriptors that are determined to independently satisfy the one or more first conditions. In various embodiments, the policy rule data object is received over a native network, and the non-native network is different from the native network. In various embodiments, the native network includes a 5th Generation System (5GS) network, and wherein the non-native network includes an Evolved Packet System (EPS) network.

According to yet another aspect of the present disclosure, another apparatus is provided. The apparatus includes means for receiving a compatibility support indication associated with a user equipment (UE). The apparatus further includes means for, for a policy rule data object including a plurality of rule descriptors, a rule descriptor of the plurality of rule descriptors including a plurality of parameters, generate a network applicability indication for a respective parameter of the plurality of parameters based at least in part on the computability support indication. The apparatus further includes means for causing transmission of the one or more policy rule data objects with the network applicability indication for the respective parameter of the plurality of parameters to the UE. The apparatus further includes means for receiving an acknowledgement of the one or more policy rule data objects and the network applicability indication for the respective parameter originating from the UE.

In various embodiments, generating the network applicability indication for the respective parameter of a rule descriptor includes determining an applicability of the rule descriptor and/or the respective parameter to a non-native network for the UE, the respective parameter defining a network connection with a native network for the UE, and generating one of a first network applicability indication value, a second network applicability indication value, or a third network applicability indication value based at least in part on the determined applicability. In various embodiments, the native network for the UE includes a 5th Generation System (5GS) network, and the non-native network includes an Evolved Packet System (EPS) network. In various embodiments, the first network applicability indication value is configured to cause the rule descriptor comprising the respective parameter associated with the first network applicability indication value to not satisfy one or more first conditions, the second network applicability indication value is configured to cause the respective parameter associated with the second network applicability indication value to not satisfy one or more second conditions, and the third network applicability indication value is configured to cause the respective parameter associated with the third network applicability indication value to satisfy the one or more second conditions.

In various embodiments, the apparatus further includes means for, responsive to the compatibility support indication indicating that the UE is not configured for a non-native network: identifying one or more of the plurality of rule descriptors that include at least one of a pre-determined set of non-applicable parameters, and generating a higher-precedence rule descriptor corresponding to a respective rule descriptor of the identified one or more rule descriptors.

In various embodiments, at least a first parameter associated with a respective network applicability indication describes one or more locations at which the UE is enabled to establish and/or use a network connection and at least a second parameter associated with a respective network applicability indication describes a time window within which the UE is enabled to establish and/or use a network connection. In various embodiments, the plurality of rule descriptors includes at least a first rule descriptor that is a traffic descriptor and one or more second rule descriptors that are route selection descriptors. In various embodiments, the plurality of rule descriptors are configured to be independently evaluated by the UE as to whether one or more first conditions are satisfied. In various embodiments, the transmission of the one or more policy rule data objects to the UE is over a native network for the UE.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms above, non-limiting and non-exhaustive embodiments of the subject disclosure will now be described with reference to the accompanying drawings, which are not necessarily drawn to scale. The components illustrated in the accompanying drawings may or may not be present in certain embodiments described herein. Some embodiments may include fewer (or more) components than those shown in the drawings.

FIG. 1 illustrates an overview of an example mobile network (e.g., EPS, 5GS), in accordance with various embodiments;

FIG. 2 provides a block diagram of interoperability of a first, or native, network (e.g., 5GS) and a second, or non-native, network (e.g., EPS) between which applicability of parameters is configured, indicated, and evaluated, in accordance with various embodiments;

FIG. 3 provides a block diagram of an example apparatus that may configure, indicate, and/or evaluate a non-native network applicability of routing parameters defined in the context of a native network, in accordance with various embodiments;

FIG. 4 illustrates a flowchart describing example operations performed for provisioning of routing policies (e.g., URSPs) for a non-native network, in accordance with various embodiments;

FIG. 5 illustrates a flowchart describing example operations performed for evaluation of network applicability indications associated with parameters during provisioning of a routing policy, in accordance with various embodiments;

FIG. 6 illustrates a flowchart describing example operations performed for configuring and indicating applicability of routing parameters to a UE, in accordance with various embodiments; and

FIG. 7 provides a message diagram illustrating an example procedure or protocol for provisioning a routing policy for applicability to a non-native network, in accordance with various embodiments.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” “electronic information,” “signal,” “command,” and similar terms may be used interchangeably to refer to data capable of being captured, transmitted, received, and/or stored in accordance with various embodiments of the present disclosure. Thus, use of any such terms should not be taken to limit the spirit and scope of embodiments of the present disclosure. Further, where a first computing device is described herein to receive data from a second computing device, it will be appreciated that the data may be received directly from the second computing device or may be received indirectly via one or more intermediary computing devices, such as, for example, one or more servers, relays, routers, network access points, base stations, hosts, repeaters, and/or the like, sometimes referred to herein as a “network.” Similarly, where a first computing device is described herein as sending data to a second computing device, it will be appreciated that the data may be sent or transmitted directly to the second computing device or may be sent or transmitted indirectly via one or more intermediary computing devices, such as, for example, one or more servers, remote servers, cloud-based servers (e.g., cloud utilities), relays, routers, network access points, base stations, hosts, repeaters, and/or the like.

The term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of. Furthermore, to the extent that the terms “includes” and “including,” and variants thereof are used in either the detailed description or the claims, these terms are intended to be inclusive in a manner similar to the term “comprising.”

The phrases “in one embodiment,” “according to one embodiment,” “in some embodiments,” “in various embodiments”, and the like generally refer to the fact that the particular feature, structure, or characteristic following the phrase may be included in at least one embodiment of the present disclosure, but not necessarily all embodiments of the present disclosure. Thus, the particular feature, structure, or characteristic may be included in more than one embodiment of the present disclosure such that these phrases do not necessarily refer to the same embodiment.

As used herein, the terms “example,” “exemplary,” and the like are used to mean “serving as an example, instance, or illustration.” Any implementation, aspect, or design described herein as “example” or “exemplary” is not necessarily to be construed as preferred or advantageous over other implementations, aspects, or designs. Rather, use of the terms “example,” “exemplary,” and the like are intended to present concepts in a concrete fashion.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

As used herein, the term “computer-readable medium” refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Examples of non-transitory computer-readable media may include, but are not limited to, one or more types of hardware memory, non-transitory tangible media (for example, one or more magnetic storage disks, one or more optical disks, one or more USB flash drives), computer system memory or random-access memory (such as, DRAM, SRAM, EDO RAM), and the like.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

In 3^{rd} Generation Partnership Project (3GPP) 5G Release 16 (Rel-16), support of UE route selection policies (URSPs) in Evolved Packet System (EPS) was introduced. UE route selection policies generally provide information on which data connection (e.g., a protocol data unit (PDU) session on a network slice in an instance of a 5GS network) a given service or application should use when exchange traffic with a network, and are primarily relevant to 5G. Thus, a Rel-16 UE can use URSPs while in EPS (S1 mode) by translating them to EPS parameters, although URSPs are still provisioned via 5G Core (5GC) networks. However, certain 5GS parameters of the rule descriptors of a URSP, which can be a Traffic Descriptor (TD) or a Route Selection Descriptor (RSD), do not have an exact equivalent in EPS. In existing UEs then, any rule descriptor that includes a parameter that is not applicable to EPS is simply ignored in EPS. For example, for certain features like edge computing, “Time Window” and “Location Criteria” are spatial and temporal parameters which are necessary to determine the validity of URSP rules (e.g., validity criteria) but are simply ignored in EPS when included in a URSP rule. Other parameters that are ignored include a Multi-Access Preference parameter and a Network Slice Selection parameter.

Although this static mapping enables the use of certain URSPs in EPS, this static mapping of applicable information in EPS is limiting. Essentially, a network operator, to ensure that the UEs in EPS behave as desired, has to design and provision EPS-specific rule descriptors and parameters. This results in unnecessary signaling, storage and processing overheads for both the UE and network, and additional network management overhead.

An example embodiment herein then provides for indicating and evaluating EPS applicability of a URSP on at least a parameter level. A policy rule data object encoding a URSP comprises a plurality of rule descriptors that may be traffic descriptors or route selection descriptors. Each rule descriptor includes a plurality of parameters, each associated with a respective network applicability indication. The network applicability indication is generated based at least in part on the applicability of the associated parameter to EPS networks and is configured to cause the parameter and/or the rule descriptor comprising the parameter to be considered or ignored when connecting to (e.g., establishing a connection session with) and/or communicating via an EPS network. In various embodiments, a UE is provided with a policy rule data object that includes network applicability indications. Using the network applicability indications, the UE evaluates the policy rule data object by determining whether to consider or ignore rule descriptors according to one or more first conditions, and then by identifying parameters of considered rule descriptors to be considered or to be ignored according to one or more second conditions.

An embodiment described herein provides various technical advantages in improved efficiency in the communication, provisioning, and evaluation of URSPs. The inclusion of network applicability indications in a policy rule data object for a URSP precludes a need to separately design and signal specific route selection policy variants for each different network. Various embodiments additionally enable a variable amount of applicable information to be used when communicating via different networks, as applicability is described on at least a parameter-level as opposed to a URSP-level, thereby enabling a UE to use as much applicable information as possible when communicating via a different network (e.g., EPS).

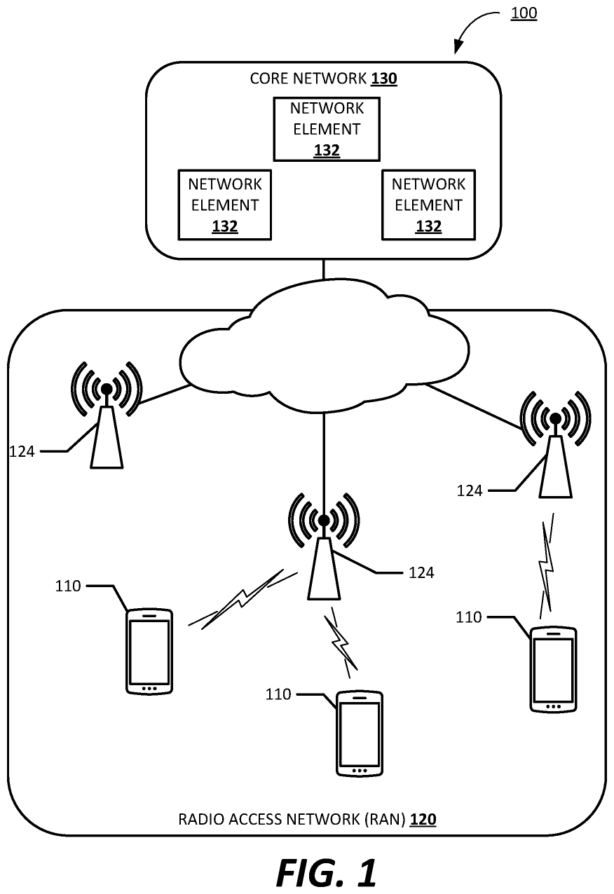

Referring now to FIG. 1, an example mobile network 100 is illustrated. Mobile network 100 (also referred to as a cellular network) is a type of network where at least the last link is wireless, and provides voice and/or data services to a plurality of devices. Mobile network 100 may be a Third Generation (3G), a Fourth Generation (4G), and/or a next generation (e.g., Fifth Generation, or 5G) network.

Mobile network 100 is illustrated as providing communication services to UEs 110. UEs 110 may be enabled for voice services, data services, Machine-to-Machine (M2M) or Machine Type Communications (MTC) services, Internet of Things (IoT) services, and/or other services. A UE 110 may be an end user device such as a mobile phone (e.g., smartphone), a tablet or PDA, a computer with a mobile broadband adapter, and/or the like.

Mobile network 100 includes one or more radio access networks (RAN 120) that communicate with UEs 110 over a radio interface. RAN 120 of one example embodiment may support Evolved-UMTS terrestrial Radio Access network (E-UTRAN) access, Wireless Local Area Network (WLAN) access, fixed access, satellite radio access, new Radio Access Technologies (RAT), and/or the like. As an example, RAN 120 may comprise an E-UTRAN or Next Generation RAN (NG-RAN) that includes one or more base stations 124 that are dispersed over a geographic area. A base station 124 may comprise an entity that uses radio communication technology to communicate with a UE on the licensed spectrum, and interface the UE with a core network 130. Base stations 124 in an E-UTRAN may be referred to as Evolved-NodeBs (eNodeB). Base stations 124 in a NG-RAN may be referred to as gNodeBs (NR base stations) and/or ng-eNodeBs (LTE base stations supporting a 5G Core Network). As another example, RAN 120 may comprise a WLAN that includes one or more Wireless Access Points (WAP). A WLAN is a network in which a UE is able to connect to a Local Area Network (LAN) through a wireless (radio) connection. A WAP is a node that uses radio communication technology to communicate with a UE over the unlicensed spectrum and provides the UE access to a core network. One example of a WAP is a Wi-Fi access point that operates on the 2.4 GHz or 5 GHz radio bands. The term “base station” then may refer to an eNodeB, a gNodeB, an ng-eNodeB, a WAP, and/or the like.

UEs 110 are able to attach to a cell of a RAN 120 to access a core network 130. RAN 120 therefore represents the radio interface between UEs 110 and core network 130. Core network 130 is the central part of mobile network 100 that provides various services to customers who are connected by RAN 120. One example of core network 130 is the Evolved Packet Core (EPC) network as described by the 3GPP for LTE. Another example of core network 130 is a 5G Core (5GC) network as described by the 3GPP. Core network 130 includes network elements 132, which may comprise servers, devices, apparatuses, or equipment (including hardware) that provide services for UEs 110. Network elements 132, in an EPC network, may comprise a Mobility Management Entity (MME), a Service Gateway (S-GW), a Packet Data Network Gateway (P-GW), and/or the like. Network elements 132, in a 5G network, may comprise an Access and Mobility Management Function (AMF), a Session Management Function (SMF), a User Plane Function (UPF), a Policy Control Function (PCF), a Unified Data Management (UDM), and/or the like.

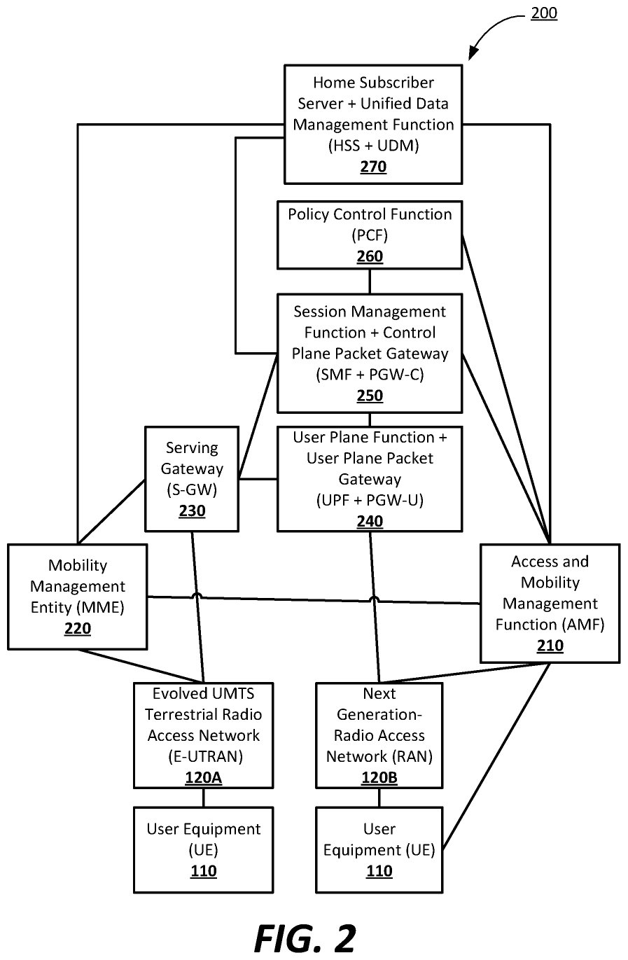

A mobile network 100 can be configured to interwork and interoperate with another mobile network 100 to improve end-to-end connectivity. In some instances, for example, a first mobile network 100 may use a second mobile network 100 as a fallback for packet communication and routing. In particular, 5GS networks have been configured for interoperability with EPS networks, such interoperability being illustrated in FIG. 2. In particular, FIG. 2 illustrates an architecture 200 including network elements 132 of 5GS networks and network elements 132 of EPS networks. Within the architecture 200, a UE 110 may connect to a 5GS network to establish a packet session (e.g., while in N1 mode) or the UE 110 may connect to an EPS network to establish a packet session (e.g., while in S1 mode). As mentioned, the UE 110 may connect to an EPS network as a fallback when 5GS networks are unavailable or do not satisfy various performance thresholds.

Thus, in the context of a 5GS network, a UE 110 may connect directly to an AMF 210 or via a ng-RAN 120B. The AMF 210 may be configured to provide UE-based authentication, authorization, mobility management, and/or the like, and the AMF 210 may be in communication with other network elements 132. For example, the AMF 210 is in communication with a SMF+PGW−C 250, which may be composed of a Session Management Function and a Control Plane Packet Gateway. The SMF+PGW−C 250 may be configured to transport data traffic between external data networks and the 5GS network and/or the EPS network. The SMF+PGW−C 250 may be further configured to provide session management, UE Internet Protocol (IP) address allocation and management, selection and control of the UPF+PGW−U 240, termination of interfaces towards the PCF 260, control part of policy enforcement and Quality of Service (QOS), lawful intercept, termination of SM parts of NAs messages, Downlink Data Notification, roaming functionality, and/or the like. In particular, the SMF+PGW−C 250 may manage sessions in 5GS network and sessions in EPC network for the UE 110. The AMF 210 of an example embodiment is further in communication with PCF 260, which is configured to support a unified policy framework to govern network behavior and to provide policy rule data objects to control plant functions, access control, traffic routing, and/or the like.

Meanwhile, the UE 110 may connect to an EPS network via E-UTRAN 120A. In particular, the EPS network includes a core network 130 with network functions 132 including MME 220 and S-GW 230. The MME 220 handles the control plane within the EPS network, for instance by handling signaling related to mobility and security for UE access to E-UTRAN 120A. Meanwhile, S-GW 230 handles the user plane of the EPS network and interconnects traffic between radio-side and the core network 130 of the EPS 20) network. In providing interoperability between the EPS network and the 5GS network, the S-GW 230 is in communication with the UPF+PGW−U 240 and the SMF+PGW−C250. Further, both of the MME 220 and the AMF 210 are in communication with an HSS+UDM 270.

Various embodiments enable UE 110 to connect to the EPS network (e.g., E-UTRAN 120A, MME 220, S-GW 230) using policy rule data objects provided by PCF 260 in a 5GS context. Specifically, UE 110 may evaluate EPS applicability of each parameter of policy rules data objects provided by PCF 260 and use applicable parameters in connecting with the EPS network and establishing sessions in the EPS network.

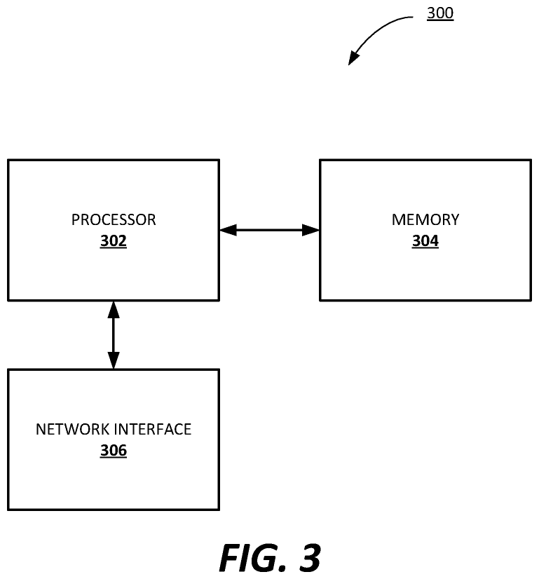

Referring now to FIG. 3, an example apparatus 300 is provided. The apparatus 300 may be an embodiment of a UE 110 and/or may be embodied by or otherwise associated with a UE 110, in some instances. Alternatively, the apparatus 300 may be an embodiment of a network element 132 or may be embodied by or otherwise associated with a network element 132, such as a PCF 260. In any regard, the apparatus 300 is configured to indicate and/or evaluate the applicability of routing parameters, such as URSP parameters. In an example embodiment, apparatus 300 is embodied by a network element 132, such as a PCF 260, and generates network applicability indications for parameters in a policy rule data object (e.g., a URSP) based at least in part on determining an applicability for the parameters to EPS networks. The apparatus 300 may then cause transmission of the policy rule data object including the network applicability indications to a UE 110, and the UE 110 may subsequently use the policy rule data object and evaluate the network applicability indications for the parameters of the policy rule data object in communicating via an EPS network. In another example embodiment, apparatus 300 is embodied by a UE 110 and receives a policy rule data object comprising network applicability indications associated with parameters. The apparatus 300 (e.g., UE 110) evaluates the network applicability indications to determine whether to ignore or consider various parameters and/or rule descriptors when communicating via an EPS network.

The apparatus 300 may include processor 302, memory 304, and network interface 306. The apparatus 300 may be configured to execute the operations described herein. Although these components are described with respect to functional limitations, it should be understood that the particular implementations necessarily include the use of particular hardware. It should also be understood that certain of these components may include similar or common hardware. For example, two sets of circuitries may both leverage use of the same processor, network interface, storage medium, or the like to perform their associated functions, such that duplicate hardware is not required for each set of circuitries.

In some embodiments, the processor 302 (and/or co-processor or any other processing circuitry assisting or otherwise associated with the processor) may be in communication with the memory 304 via a bus for passing information among components of the apparatus. The memory 304 is non-transitory and may include, for example, one or more volatile and/or non-volatile memories. In other words, for example, the memory 304 may be an electronic storage device (e.g., a computer-readable storage medium). The memory 304 may be configured to store information, data, content, applications, instructions, or the like for enabling the apparatus to carry out various functions in accordance with an example embodiment disclosed herein.

The processor 302 may be embodied in a number of different ways and may, for example, include one or more processing devices configured to perform independently. In some non-limiting embodiments, the processor 302 may include one or more processors configured in tandem via a bus to enable independent execution of instructions, pipelining, and/or multithreading. The use of the term “processor” may be understood to include a single core processor, a multi-core processor, multiple processors internal to the apparatus, and/or remote or “cloud” processors.

In some embodiments, the processor 302 may be configured to execute instructions stored in the memory 304 and/or circuitry otherwise accessible to the processor 302, such as instructions for indicating and evaluating EPS applicability of URSP parameters of a policy rule data object. In some embodiments, the processor 302 may be configured to execute hard-coded functionalities. As such, whether configured by hardware or software methods, or by a combination thereof, the processor 302 may represent an entity (e.g., physically embodied in circuitry) capable of performing operations according to an embodiment disclosed herein while configured accordingly. Alternatively, as another example, when the processor 302 is embodied as an executor of software instructions, the instructions may specifically configure the processor 302 to perform the algorithms and/or operations described herein when the instructions are executed.

In some embodiments, the apparatus 300 may include input/output circuitry that may, in turn, be in communication with processor 302 to provide output to a user and/or other entity and, in some embodiments, to receive an indication of an input. The input/output circuitry may comprise a user interface and may include a display, and may comprise a web user interface, a mobile application, a query-initiating computing device, a kiosk, or the like. In some embodiments, the input/output circuitry may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 304, and/or the like).

The network interface 306 may be any means such as a device or circuitry embodied in either hardware or a combination of hardware and software that is configured to receive and/or transmit data from/to a network and/or any other device, circuitry, or module in communication with the apparatus 300. In this regard, the network interface 306 may include, for example, a network interface for enabling communications with a wired or wireless communication network. For example, the network interface 306 may include one or more network interface cards, antennae, buses, switches, routers, modems, and supporting hardware and/or software, or any other device suitable for enabling communications via a network. Additionally, or alternatively, the network interface 306 may include the circuitry for interacting with the antenna/antennae to cause transmission of signals via the antenna/antennae or to handle receipt of signals received via the antenna/antennae.

It is also noted that all or some of the information discussed herein can be based on data that is received, generated and/or maintained by one or more components of apparatus 300. In some embodiments, one or more external systems (such as a remote cloud computing and/or data storage system) may also be leveraged to provide at least some of the functionality discussed herein.

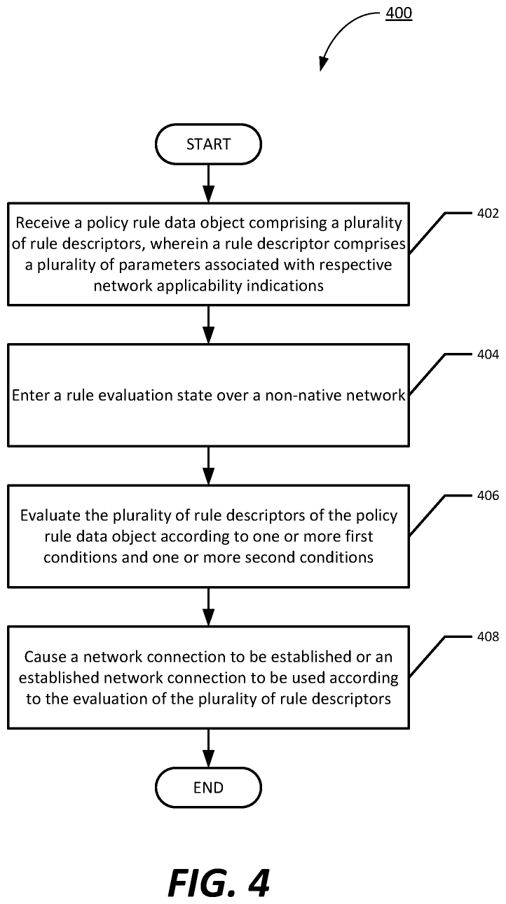

Referring now to FIG. 4, a flowchart 400 is provided. The flowchart 400 illustrates example operations that are performed by the UE 110 (e.g., which may be embodied by apparatus 300), in some example embodiments. In particular, the flowchart 400 includes various operations performed by the UE 110 for evaluating the applicability of parameters of a URSP to EPS networks.

As shown, at operation 402, the UE 110 receives a policy rule data object comprising a plurality of rule descriptors. Each rule descriptor comprises a plurality of parameters associated with respective network applicability indications. The apparatus 300 embodied by or otherwise associated with the UE 110 includes means, such as the processor 302, memory 304, network interface 306, and/or the like, for receiving a policy rule data object that comprises a plurality of rule descriptors each comprising a plurality of parameters associated with respective network applicability indications. In some embodiments, the policy rule data object may comprise one or more rule descriptors and a rule descriptor comprises one or more parameters associated with respective network applicability indications. In various embodiments, the policy rule data object originates from a PCF 260 of a 5G system and is received subsequent to the UE 110 transmitting a compatibility support indication. The compatibility support indication is transmitted by the UE 110 during registration related signaling to the AMF 210, and the AMF 210 provides the compatibility support indication to the PCF 260. The compatibility support indication indicates whether the UE 110 is configured to and capable of evaluating an EPS applicability of parameters of the URSP using network applicability indications of the policy rule data object and is provided to the PCF 260 such that the PCF 260 is aware of such compatibility of the UE 110 during policy making for the UE 110. In some instances, operation 402 is performed such that UE 110 receives multiple policy rule data objects.

A policy rule data object specifically refers to a data object configured to encode information of and related to a URSP, and Table 1 illustrates an example configuration of a policy rule data object.

TABLE 1

| | | | | | | | |
|---|---|---|---|---|---|---|---|
| 8 | 7 | 6 | 5 | 4 | 3 | 2 | 1 |

| | |
|---|---|
| Length of URSP rule | octet v |
| | octet v + 1 |
| Precedence value of URSP rule | octet v + 2 |
| Length of traffic descriptor | octet v + 3 |
| | octet v + 4 |
| Traffic descriptor | octet v + 5 |
| | octet w |
| Length of route selection descriptor list | octet w + 1 |
| | octet w + 2 |
| Route selection descriptor list | octet w + 3 |
| | octet x |

As shown, a policy rule data object may be comprised of a plurality of octets that encode relevant information of a URSP. For example, the policy rule data object is configured to indicate a length and/or size of the policy rule data object (e.g., itself). In instances in which multiple policy rule data objects are received and/or stored by the UE 110, a policy rule data object comprises a precedence value. The precedence value may indicate a sequential order in which multiple policy rule data objects are evaluated and/or indicate a relative priority or importance (e.g., to override, to overwrite) of a respective policy rule data object with respect to other policy rule data objects. As also shown, the policy rule data object comprises a plurality of rule descriptors, including a traffic descriptor and one or more route selection descriptors. The policy rule data object may then indicate a total size of the rule descriptors and/or a number of rule descriptors included in the policy rule data object.

Table 2 below illustrates an example configuration of a rule descriptor, and specifically an example configuration of a rule descriptor that is a route selection descriptor of a policy rule data object.

TABLE 2

| | | | | | | | |
|---|---|---|---|---|---|---|---|
| 8 | 7 | 6 | 5 | 4 | 3 | 2 | 1 |

| | |
|---|---|
| Length of route selection descriptor | octet b |
| | octet b + 1 |
| Precedence value of route selection descriptor | octet b + 2 |
| Length of route selection descriptor contents | octet b + 3 |
| | octet b + 4 |
| Route selection descriptor contents | octet b + 5 |
| | octet c |

Similarly, the rule descriptor may indicate a length and/or size of itself. The rule descriptor further comprises a precedence value describing a sequential order for evaluation and/or a priority relative to other rule descriptors of the policy rule data object. The rule descriptor comprises a plurality of parameters (e.g., components, contents) and is configured to indicate a total size and/or a number of parameters included in the rule descriptor.

Table 3 below then illustrates an example configuration of a parameter of a rule descriptor. For example, the example parameter may be included in a rule descriptor that is a traffic descriptor or a rule descriptor that is a route selection descriptor.

TABLE 3

| | | | | | | | |
|---|---|---|---|---|---|---|---|
| 8 | 7 | 6 | 5 | 4 | 3 | 2 | 1 |

| | |
|---|---|
| Route selection descriptor component type | octet k |
| Route selection descriptor component value field | octet k + 1 |
| | octet I |
| EPS applicability indication | octet I + 1* |

As shown, the parameter (e.g., also referred by Table 3 as a component) comprises data describing the parameter type of the parameter. Various parameter types of parameters included in route selection descriptors may include a Session and Service Continuity (SSC) Mode Selection parameter, a Network Slice Selection parameter, DNN Selection parameter, PDU Session Type Selection parameter, a Non-Seamless Offload Indication parameter, an Access Type Preference parameter, a Multi-Access preference parameter, a Time Window parameter, and a Location Criteria parameter. The parameter may indicate its parameter type with an identifier, code, value, and/or the like unique to a parameter type.

The parameter further comprises a particular value, which may encode a particular meaning according to the parameter type. For instance, a particular value for a parameter that is an SSC Mode Selection parameter corresponds to a particular SSC mode. As another example, a “0” value for a parameter of the Access Type Preference type indicates a 3GPP preferred access type, while a “1” value for a parameter of the Access Type Preference type indicates a non-3GPP preferred access type. As a further example, a Location Criteria parameter may comprise values that are particular coordinates. In various embodiments, a rule descriptor may include multiple parameters of the same parameter type, and the multiple parameters of the same parameter type may have different values.

As further shown in Table 3, the parameter further comprises a network applicability indication (e.g., “EPS applicability indication” in Table 3). As discussed, the network applicability indication indicates the applicability of the parameter to another network, such as an EPS network. In particular, the network applicability indication can be one of at least a first network applicability indication value (e.g., encoded with a value of “00”), a second network applicability indication value (e.g., encoded with a value of “01”), or a third network applicability indication value (e.g., encoded with a value of “10”). The first network applicability indication value indicates that the parameter is not applicable to the other network (e.g., EPS). The second network applicability indication value indicates that the parameter should be ignored in the other network (e.g., EPS). The third network applicability indication value indicates that the parameter is applicable to the other network (e.g., EPS).

Thus, this parameter-level indication of applicability enables improved flexibility and configuration of URSPs for different networks. For instance, a rule descriptor may include at least two Location Criteria parameters, one that describes locations for 5GS network connection and comprising a second network applicability indication value (e.g., to be ignored in EPS) and another that describes locations for EPS network connection and comprising a third network applicability indication value (e.g., applicable to EPS). Although specific example configurations of a policy rule data object, a rule descriptor, and a parameter are provided by Tables 1-3, respectively, these configurations are provided by way of example and are not of limitation. A policy rule data object, a rule descriptor, and/or a parameter may have different configurations and may include at least some different and/or values, fields, configuration, parameters, and/or the like in other embodiments.

At operation 404, the UE 110 enters a rule evaluation state over a non-native network. As such, the apparatus 300 embodied by or otherwise associated with the UE 110 comprises means, such as processor 302, memory 304, and/or the like, for entering the rule evaluation state over the non-native network. The rule evaluation state may refer to a state in which the UE 110 is configured to communicate with the non-native network (e.g., EPS). In various embodiments, the rule evaluation state over the non-native type of network is the S1 mode, in which the UE 110 communicates (e.g., via E-UTRAN 120A) with MME 220 to connect to an EPS network. In various embodiments, entering a rule evaluation state comprises identifying and/or retrieving one or more policy rule data objects from memory. For example, the policy rule data object received by the UE 110 (e.g., in operation 402) may be stored in memory 304 (when the UE 110 is embodied by apparatus 300) for later retrieval when the UE 110 enters a rule evaluation state.

At operation 406, the UE 110 evaluates a policy rule data object on a rule descriptor level and a parameter level. The apparatus 300 embodied by or otherwise associated with the UE 110 comprises means, such as processor 302, memory 304, and/or the like, for evaluating a policy rule data object and evaluating EPS applicability of parameters of a URSP. Specifically, the UE 110 evaluates the plurality of rule descriptors of the policy rule data object according to one or more first conditions, and further evaluates parameters of a rule descriptor satisfying the one or more first conditions according to one or more second conditions. Operation 406 may be performed such that the UE 110 evaluates rule descriptors and parameters of multiple policy rule data objects, such as in instances in which a URSP includes multiple policy rule data objects. Operation 406 may then be performed sequentially for each policy rule data object according to precedence values associated with each policy rule data object. For example, the policy rule data object with the highest precedence value may be evaluated first, followed by the policy rule data object with the next highest precedence value, and so on.

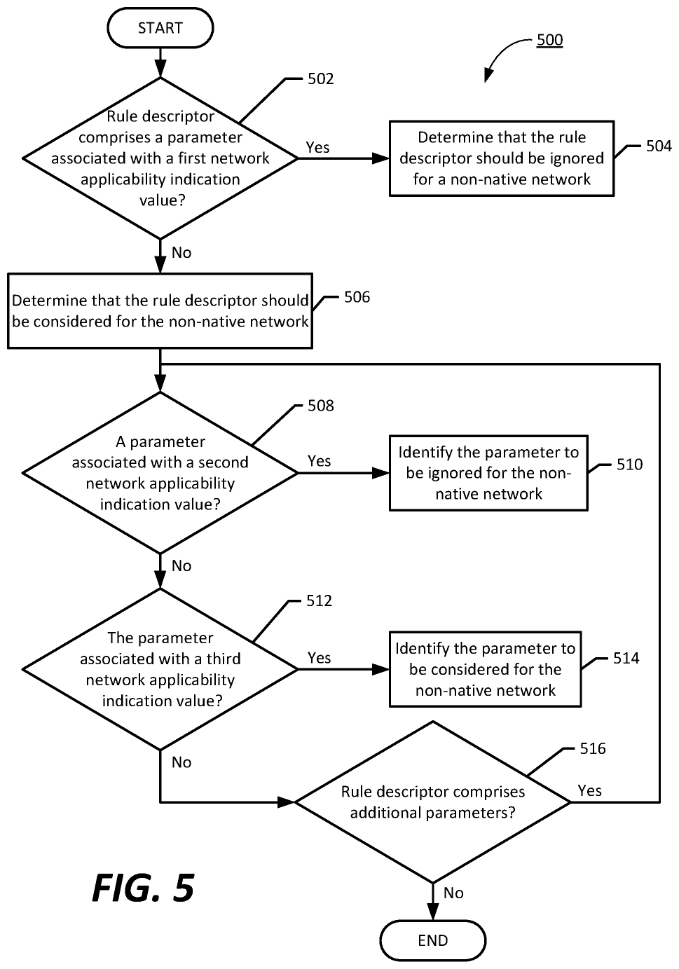

Operation 406 for evaluating a policy rule data object is illustrated in accordance with one example embodiment by flowchart 500 of FIG. 5. That is, flowchart 500 include example operations for evaluating a plurality of rule descriptors of a policy rule data object according to one or more first conditions and evaluating parameters according to one or more second conditions. Flowchart 500 specifically describes evaluation of a given rule descriptor and parameters thereof, and the example operations of flowchart 500 may be repeatedly performed for each rule descriptor of a policy rule data object in order to fully evaluate the policy rule data object. The rule descriptors of a policy rule data object may comprise precedence values, which may then control a sequential order or priority with which the rule descriptors are evaluated using the example operations of flowchart 500. For instance, the rule descriptor with the highest precedence value is evaluated first, followed by the rule descriptor with the next highest precedence value, and so on. As previously discussed, a rule descriptor can be a traffic descriptor of a URSP rule or a Route selection descriptor of a URSP rule.

At operation 502, the UE 110 determines whether the given rule descriptor comprises at least one parameter associated with a first network applicability indication value. In this regard, the apparatus 300 embodied by or otherwise associated with the UE 110 may include means, such as the processor 302, the memory 304 or the like, for determining whether the given rule descriptor comprises at least one parameter associated with a first network applicability indication value. In an example embodiment, the first network applicability indication value is a network applicability indication with the value of “00”. The first network applicability indication value (e.g., “00”) is configured to indicate that an associated parameter is not applicable to the non-native network (e.g., EPS). The network applicability indication may have another predefined value in other example embodiments.

If at least one parameter of the given rule descriptor is associated with the first network applicability indication value (e.g., “00”), then the flowchart 500 proceeds to operation 504, at which the UE 110 determines that the given rule descriptor does not satisfy the one or more first conditions and that the given rule descriptor should be ignored when connecting to and/or communicating via the non-native network (e.g., EPS). As a result, the apparatus 300 embodied by or otherwise associated with the UE 110 may include means, such as the processor 302, the memory 304 or the like, for determining that the given rule descriptor does not satisfy the first condition(s) and that the given rule descriptor should be ignored when connecting to and/or communicating via the non-native network. That is, the one or more first conditions include the condition that the given rule descriptor does not include any parameters with the first network applicability indication value, or parameters that are not applicable to the non-native network (e.g., EPS), and a rule descriptor with any parameters that are not applicable should be ignored. Accordingly, the evaluation of the given rule descriptor may conclude, and the UE 110 may continue to evaluate subsequent rule descriptors if any remain in the policy rule data object (e.g., returning to operation 502).

Otherwise, the flowchart 500 proceeds to operation 506 in instances in which the UE 110 determines that the given rule descriptor does not include any parameters associated with the first network applicability indication value (e.g., “00”) and that the given rule descriptor should be considered when connecting to and/or communicating via the non-native network (e.g., EPS). At operation 506, the UE 110 determines that the given rule descriptor satisfies the one or more first conditions (e.g., by not including any parameters associated with the “00” network applicability indication), such that the apparatus 300 embodied by or otherwise associated with the UE 110 includes means, such as processor 302, memory 304, and/or the like, for determining that a rule descriptor satisfies the one or more first conditions. As the given rule descriptor can be considered, the parameters of the given rule descriptor are then evaluated. That is, evaluation of the policy rule data object on a rule descriptor level may be followed by evaluation of the policy rule data object on a parameter level when the one or more first conditions are satisfied. In an example embodiment, the UE 110 is configured to evaluate the parameters of the given rule descriptor sequentially, in a particular order, in parallel, and/or the like.

At operation 508, the UE 110 then determines whether a particular parameter of the given rule descriptor is associated with a second network applicability indication value. As such, the apparatus 300 embodied by or otherwise associated with the UE 110 includes means, such as processor 302, memory 304, and/or the like, for determining whether a particular parameter of the given rule descriptor is associated with the second network applicability indication value. In an example embodiment, the second network applicability indication value is a network applicability indication with the value of “01”, although the second network applicability indication value may have other predefined values in other embodiments. The second network applicability indication value is configured to indicate that an associated parameter should be ignored when connecting to and/or communicating via the non-native network (e.g., EPS). Advantageously, a particular parameter associated with the second network applicability indication value is ignored, in lieu of ignoring the entire rule descriptor comprising the particular parameter. That is, individual parameters can be indicated to be ignored without causing an entire rule descriptor to be ignored. Thus, an evaluation of information at a higher resolution (e.g., on a parameter level) is provided in various embodiments of the present disclosure.

If the particular parameter is associated with a second network applicability indication value, the flowchart 500 proceeds to operation 510, at which the UE 110 identifies the particular parameter as not satisfying the one or more second conditions and to be ignored when connecting to and/or communicating via the non-native network (e.g., EPS). The apparatus 300 embodied by or otherwise associated with the UE 110 comprises means, such as processor 302, memory 304, and/or the like, for identifying the particular parameter as not satisfying the one or more second conditions and to be ignored. The one or more second conditions include a condition that a parameter is not associated with the second network applicability indication value (e.g., “01”), and failure to satisfy the one or more second conditions results in the parameter being ignored when connecting to and/or communicating via the non-native network (e.g., EPS).

Otherwise, the flowchart proceeds to operation 512, at which the UE 110 determines whether the particular parameter is associated with a third network applicability indication value. The apparatus 300 embodied by or otherwise associated with the UE 110 may therefore comprise means, such as process 302, memory 304, and/or the like, for determining whether the particular parameter is associated with the third network applicability indication value. In an example embodiment, the third network applicability indication value is a network applicability indication with the value of “10”, although the third network applicability indication value may have another predefined value in other embodiments. The third network applicability indication value is configured to indicate that an associated parameter is applicable to the non-antive network (e.g., EPS), or specifically, applicable in connecting to and/or communicating via the non-native network.

If the particular parameter is associated with the third network applicability indication value (e.g., “10”), the flowchart 500 proceeds to operation 514, at which the UE 110 identifies the particular parameter as satisfying the one or more second conditions and to be considered when connecting to and/or communicating via the non-native network (e.g., EPS). The apparatus 300 embodied by or otherwise associated with the UE 100 of this example embodiment includes means, such as processor 302, memory 304, and/or the like, for identifying the particular parameter as satisfying the one or more second conditions and to be considered. The one or more second conditions include a condition that a parameter is associated (e.g., positively, explicitly, definitively) with the third network applicability indication value, and satisfying the one or more second conditions results in the parameter being considered when connecting to and/or communicating via the non-native network (e.g., EPS).

As an example, validity constraints, which are parameters defined in the context of a 5GS network, can be applied to EPS networks and may be associated with the third network applicability indication value (e.g., “10”). As another example, parameters for network slicing that are defined in the context of a 5GS network can be applied to EPS networks in various embodiments when associated with the third network applicability indication value. In doing so, other related parameters for network slicing, such as Single-Network Slice Selection Assistance Information (S-NSSAI) parameters, can be ignored by being associated with the second network applicability indication value (e.g., “01”). Thus, various functionality can be applied to EPS by configuring applicability of certain parameters within a rule descriptor and a policy rule data object.

The validity constraints and/or other parameters can include time-based constraints, such as a time window within which the UE 110 can connect with a network. The validity constraint and/or other parameters can further include location-based constraints. As an example, a URSP that is to be valid for a particular geographical area that is not fully covered by 5GS networks can be described by a policy rule data object with a Location Criteria parameter describing specific location information related to the areas that are fully covered by 5GS networks. The policy rule data object can include additional Location Criteria parameters describing location information related to areas that are not covered by 5GS networks but are covered by EPS networks. Then, the parameters describing location information related to areas that are fully covered by 5GS networks can be associated with second network applicability indication values (e.g., “01”) such that they are ignored in EPS networks, and the parameters describing location information not covered by 5GS networks but covered, instead, by EPS networks can be associated with third network applicability indication values (e.g., “10”) such that they are considered in EPS networks. Thus, unique and flexible applicability of related information can be enabled in various embodiments of the present disclosure.

If the UE 110 otherwise determines that the particular parameter is not associated with the third network applicability indication value (e.g., “10”), the UE 110 determines that the particular parameter does not positively satisfy the one or more second conditions, and operation 516 may then be performed. Operation 516 involves determining whether the given rule descriptor (determined to satisfy the one or more first conditions at operations 502 and 506) includes any remaining parameters. The apparatus 300 embodied by or otherwise associated with the UE 110 of this example embodiment includes means, such as processor 302, memory 304, and/or the like, for determining whether the given rule descriptor includes any remaining parameters, or any parameters not evaluated and identified to be ignored or to be considered. As discussed, each parameter of a rule descriptor that satisfies the one or more first conditions is evaluated according to the one or more second conditions. Thus, if any un-evaluated parameters of the rule descriptor remain, the flowchart 500 returns to operation 508 to initiate evaluation of a yet un-evaluated parameter.

Otherwise, flowchart 500 may conclude if each parameter of the given rule descriptor has been evaluated according to one or more second conditions, and each parameter has been identified to be ignored or to be considered when connecting to/communicating via the network. Accordingly, evaluation of the given rule descriptor may conclude, and another rule descriptor of the policy rule data object may be evaluated through the example operations of flowchart 500. The next rule descriptor of the policy rule data object to be evaluated may be determined according to precedence values of each rule descriptor of the policy rule data object.

Thus, as discussed, flowchart 500 may be an example embodiment of operation 406. Returning to FIG. 4, at operation 408, the UE 110 causes a network connection to be established or an established network connection to be used, according to the evaluation of the plurality of rule descriptors. The apparatus 300 embodied by or otherwise associated with the UE 110 of this example embodiment comprises means, such as processor 302, memory 304, network interface 306, and/or the like, for causing a network connection to be established and/or an established network connection to be used according to the evaluation of the plurality of rule descriptors. As the UE 110 is in a rule evaluation state (e.g., S1 mode), the UE 110 may cause the network connection to be established with an EPS network based at least in part on the evaluation of EPS applicability of the rule descriptors and parameters thereof. Similarly, the UE 110 may use an established network connection with an EPS network based at least in part on the evaluation of EPS applicability of the rule descriptors and parameters thereof. In particular, the UE 110 causes the network connection to be established and/or the established network connection to be used using rule descriptors that satisfy the one or more first conditions (e.g., not including any parameters associated with a “00” network applicability indication) and specifically, parameters of such rule descriptors that satisfy the one or more second conditions (e.g., not being associated with a “01” network applicability indication and, instead, being associated with a “10” network applicability indication). Thus, the UE 110 uses considered parameters of a URSP in connecting to and communicating via an EPS network.

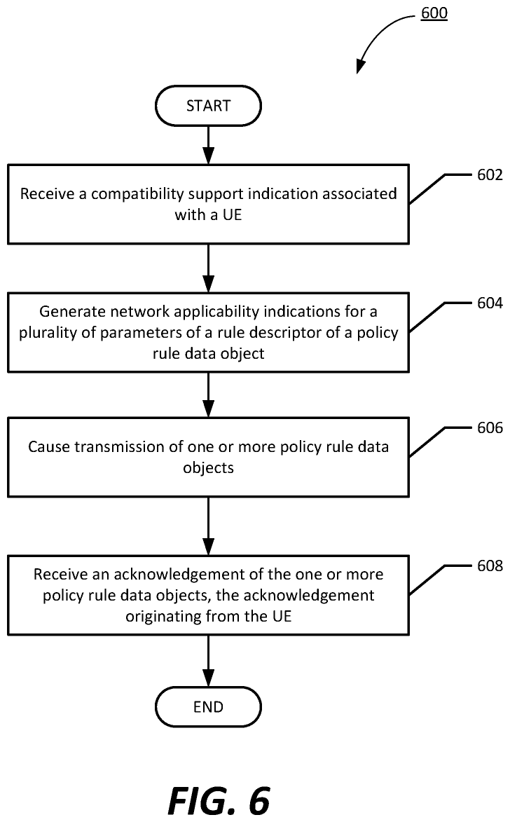

Referring now to FIG. 6, a flowchart 600 is provided. The flowchart 600 illustrates example operations that may be performed by a network element 132, such as a PCF 260, in some example embodiments. For example, the flowchart 600 includes various example operations performed by the PCF 260 for indicating applicability of parameters of a URSP to a UE 110.

At operation 602, the PCF 260 receives a compatibility support indication associated with a UE 110, and the apparatus 300 embodied by or otherwise associated with the PCF 260 of this example embodiment comprises means, such as processer 302, memory 304, network interface 306, and/or the like, for receiving a compatibility support indication associated with the UE 110. The compatibility support indication is received by exchange of signaling between the UE 110 and a 5GS network, such as during registration related signaling, and accordingly, the compatibility support indication is received via the 5GS network. The compatibility support indication is then transferred, forwarded, and/or provided to the PCF 260 such that the PCF 260 receives the compatibility support indication. Specifically, the AMF 210 may first receive the compatibility support indication from the UE 110 during registration related signaling, and the AMF 210 subsequently provides the compatibility support indication to the PCF 260. As understood by those of skill in the field to which the present disclosure pertains, the compatibility support indication of an example embodiment is provided by the UE 110 together with various information used to register the UE 110 with the 5GS network, the information including UE policy section identifier (UPSI) lists, UE policy classmarks, UE identifier, UE operating system identifiers, and/or the like. The compatibility support indication indicates whether the UE 110 is capable of and/or enabled to connect to EPS networks and whether the UE 110 is configured to evaluate applicability of URSP parameters in accordance with various embodiments of the present disclosure.

In some instances, the compatibility support indication does not indicate that the UE 110 is capable of and/or enabled to connect to non-native networks (e.g., EPS) or that the UE 110 is configured to evaluate applicability of URSP parameters in accordance with various embodiments of the present disclosure. In such instances, the PCF 260 may automatically generate a new rule descriptor for each rule descriptor of a policy rule data object that contains at least one of a set of pre-determined parameters. Specifically, the new rule descriptor that is generated for a rule descriptor that contains at least one of a set of pre-determined parameters has a higher precedence value compared to that of the rule descriptor for which the new rule descriptor was generated (e.g., the existing rule descriptor). Thus, the new rule descriptor is a higher-precedence rule descriptor. The higher-precedence rule descriptor may comprise a precedence value that is incremented (e.g., or one greater than) the precedence value of the existing rule descriptor. In various embodiments, the set of pre-determined parameters includes an SSC Mode Selection parameter, a Network Slice Selection parameter, a Multi-Access Preference parameter, a Time Window parameter, and/or a Location Criteria parameter.

Each of the set of pre-determined parameters may be parameters that are determined in existing systems to be not applicable to a non-native network for the UE 110, such as EPS networks. Thus, various embodiments provide a backwards compatibility solution for UEs 110 that are not configured to evaluate URSPs on at least a parameter level in accordance with some embodiments of the present disclosure, the backwards compatibility solution involving the generation of higher-precedence rule descriptors for rule descriptors comprising a non-applicable parameter.

Otherwise, the compatibility support indication indicates that the UE 110 is configured to evaluate applicability of URSPs on a parameter level (e.g., using network applicability indications), and at operation 604, the PCF 260 generates network applicability indications for a plurality of parameters of a rule descriptor of a policy rule data object. The apparatus 300 embodied by or otherwise associated with the PCF 260 of an example embodiment includes means, such as processor 302, memory 304, and/or the like, for generating network applicability indications for a plurality of parameters of a rule descriptor of a policy rule data object. In various instances, multiple policy rule data objects are identified to be provided to the UE 110, and PCF 260 performs operation 604 so that a network applicability indication is generated for and associated with each parameter of each rule descriptor (e.g., a traffic descriptor, a route selection descriptor) of each policy rule data object.

In various embodiments, the respective network applicability indication is generated based at least in part on determining (e.g., referencing, simulating, receiving and/or the like) an applicability of an associated parameter to the non-native network for the UE, for example, an EPS network. For example, the PCF 260 determines whether the associated parameter is non-applicable to EPS networks, is to be ignored for EPS networks, or is applicable to EPS networks. Based at least in part on the determined applicability of the associated parameter, a value for the respective network applicability indication is generated. For example, the first network applicability indication value (e.g., a value of “00”) is generated for an associated parameter that is non-applicable to EPS networks. As another example, the second network applicability indication value (e.g., a value of “01”) is generated for an associated parameter that is to be ignored for EPS networks. As yet another example, the third network applicability indication value (e.g., a value of “10”) is generated for an associated parameter that is applicable to EPS networks. In various embodiments, a respective network applicability indication is an octet appended to the parameter. Thus, in various embodiments, operation 604 is performed such that each parameter of each rule descriptor of each policy rule data object to be provided to the UE 110 is associated with a network applicability indication (e.g., “00”, “01”, “10”).

At operation 606, the PCF 260 causes transmission of one or more policy rule data objects to the UE 110. The apparatus 300 embodied by or otherwise associated with the PCF 260 comprises means, such as processor 302, memory 304, network interface 306, and/or the like, for causing transmission of a policy rule data object to a UE 110. In various embodiments, operation 606 may correlate with operation 402, at which the UE 110 receives a policy rule data object. In this example embodiment, as the PCF 260 is a network element 132 of a 5GS network and the UE 110 is registering and/or registered with the 5GS network, it may be clear that the one or more policy rule data objects are transmitted to the UE 110 over the 5GS network, or generally a native network for the UE 110. In various embodiments, the one or more policy rule data objects may be transmitted with a UE policy section management list.

At operation 608, the PCF 260 receives an acknowledgement of the one or more policy rule data objects, the acknowledgement originating from the UE 110. Essentially, the acknowledgement confirms the receipt at the UE 110 of the one or more policy rule data objects. The apparatus 300 embodied by or otherwise associated with the PCF 260 of this example embodiment includes means, such as processor 302, memory 304, network interface 306, and/or the like, for receiving acknowledgement originating from the UE 110 confirming receipt of one or more policy rule data objects. Similarly, the acknowledgement may be communicated by the UE 110 over the 5GS network to the PCF 260, or generally the native network for the UE 110. In various embodiments, the acknowledgement represents a confirmation from the UE 110 that the UE 110 has stored the one or more policy rule data objects comprising and/or along with the network applicability indications for each parameter.

In some instances, the PCF 260 may fail to receive an acknowledgement originating from the UE 110 within a configurable time period. In other instances the PCF 260 may explicitly receive an indication that receipt of the one or more policy rule data objects by the UE 110 has failed. In any such instances, the PCF 260 may be configured to cause another transmission of the one or more policy rule data objects to the UE 110 after indicated and/or presumed failure of storage of the one or more policy rule data objects with the network applicability indications for each parameter.

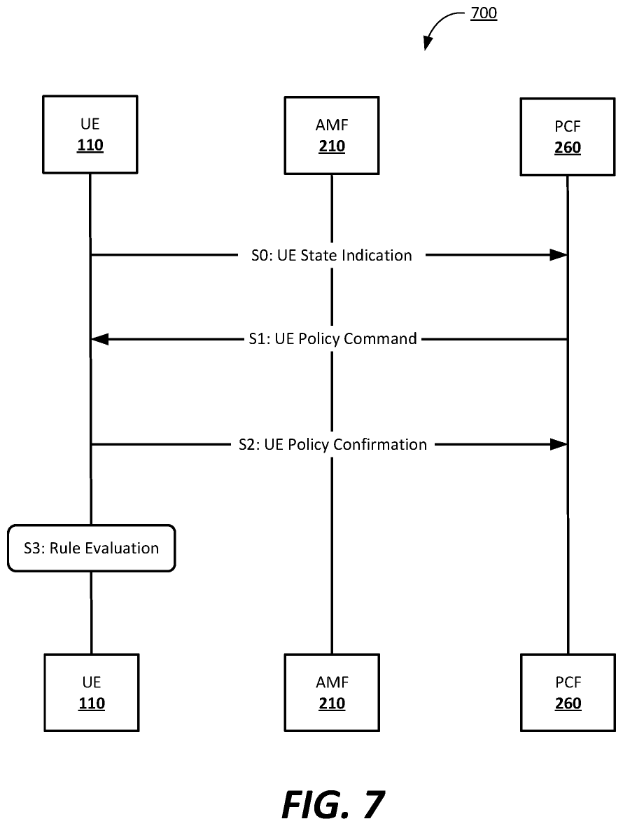

Referring now to FIG. 7, a message diagram 700 is provided. The message diagram 700 illustrates an overview of example operations performed in accordance with one example embodiment by at least the UE 110 and the PCF 260, such as during a URSP provisioning protocol. For example, the example operations of the message diagram 700 are performed such that the PCF 260 indicates EPS applicability of parameters of policy rule data objects to the UE 110, and the UE 110 uses the indicated EPS applicability of parameters when connecting to and/or communicating via EPS networks. The message diagram 700 may generally include example operations discussed in the context of flowcharts 400, 500, and 600.

Step 0 of the message diagram 700 involves the provision of a state indication by the UE 110 to the PCF 260, and may involve registration related signaling. In various embodiments, state indication specifically involves transmission of a compatibility support indication by the UE 110 to the AMF 210 and forwarding of the compatibility support indication or some related indication thereof by the AMF 210 to the PCF 260. The forwarding and receipt of the compatibility support indication by the PCF 260 may occur at some point in time subsequent to registration related signaling by the UE 110. Thus, in example instances, the compatibility support indication is transmitted originating from the UE 110 to the AMF 210, and the AMF 210 provides the compatibility support indication to the PCF 260. In an example embodiment, the AMF 210 and the PCF 260 are configured to communicate with each other via a N15 interface, and the compatibility support indication is provided to the PCF 260 by the AMF 210 via the N15 interface. Step 0 may correlate with operations 602, at which the PCF 260 receives a compatibility support indication associated with the UE 110.

Step 1 of the message diagram 700 involves provision of the UE policy command by the PCF 260 to the UE 110. Step 1 may involve the transmission of one or more policy rule data objects by the PCF 260 to the UE 110, and the one or more policy rule data objects include network applicability indications associated with the parameters of rule descriptors (e.g., traffic descriptors, route selection descriptors) of the one or more policy rule data objects. Similarly, the one or more policy rule data objects may be relayed by the AMF 210; for example, the PCF 260 provides the one or more policy rule data objects to the AMF 210, which then transmits the one or more policy rule data objects to the UE 110. Step 1 may correlate with operation 606, at which the PCF 260 causes transmission of one or more policy rule data objects, and with operation 402, at which the UE 110 receives a policy rule data object. It will be understood that Step 1 may be performed as a direct consequence of Step 0, in some example instances. In other example instances, Step 1 is performed much later than Step 0 (e.g. when user subscription or network configuration has been modified while the UE 110 has already provided the compatibility support indication (step 0) to the PCF 260 a long while ago).

Step 2 of the message diagram 700 involves UE policy confirmation by the UE 110 to the PCF 260. Step 2 may involve the transmission of an acknowledgement of the one or more policy rule data objects, the acknowledgement originating from the UE 110 and received by the PCF 260. Again, the acknowledgement may be relayed by the AMF 210, such that the AMF 210 receives the acknowledgement and provides the acknowledgement to the PCF 260. Step 2 may correlate with operation 608, at which the PCF 260 receives an acknowledgement originating from the UE 110 of the one or more policy rule data objects.

Step 3 of the message diagram 700 then involves rule evaluation by the UE 110. Rule evaluation may be embodied by at least a portion of flowchart 400 and flowchart 500 and involves evaluating the plurality of rule descriptors of a policy rule data object according to one or more first conditions and evaluating parameters of a rule descriptor satisfying the one or more first conditions according to one or more second conditions. As a result of rule evaluation, certain rule descriptors are determined to be ignored, while other rule descriptors are determined to be considered. For a rule descriptor that is determined to be considered, certain parameters are identified to be ignored, while other parameters are identified to be considered. With rule evaluation then, the UE 110 may establish and/or use a connection (e.g., a packet session) with an EPS network using rule descriptors and parameters to be considered. In various embodiments, Step 3 of the message diagram 700 is performed when the UE 110 enters a rule evaluation state, such as S1 mode.

Accordingly, various embodiments provide various technical advantages that include improved efficiency in the communication, provisioning, and evaluation of URSPs. The inclusion of network applicability indications in a policy rule data object for a URSP precludes a need to separately design and signal specific route selection policy variants for each different network. Various embodiments additionally enable a variable amount of applicable information to be used when communicating via different networks, as applicability is described at a parameter-level as opposed to a URSP-level, thereby enabling a UE to use as much applicable information as possible when communicating via a different network (e.g., EPS).

FIGS. 4, 5 and 6 illustrate flowcharts depicting operations according to an example embodiment of the present disclosure. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures or operations described above may be embodied by computer program instructions. In this regard, the computer program instructions which embody the procedures or operations described above may be stored by a memory 304 of an apparatus (e.g., apparatus 300, UE 110, PCF 260) employing an embodiment of the present invention and executed by a processor 302. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

The invention claimed is:

1. An apparatus comprising:
at least one processor; and
at least one memory storing computer program code,
the computer program code comprising instructions which, when executed by the at least one processor, cause the apparatus at least to perform:
receiving a policy rule data object comprising a plurality of rule descriptors, respective rule descriptors of the plurality of rule descriptors comprising a plurality of parameters associated with respective network applicability indications; and
upon entering a rule evaluation state over a non-native network, for each respective rule descriptor of the plurality of rule descriptors:
determine whether the respective rule descriptor of the plurality of rule descriptors satisfies one or more first conditions based at least on the respective network applicability indications associated with the respective parameters of the respective rule descriptor,
in an instance in which the respective rule descriptor is determined to satisfy the one or more first conditions, identifying at least one parameter of the respective rule descriptor that satisfies one or more second conditions based at least on the respective network applicability indications associated with the respective parameter, and
causing a network connection to be established or an established network connection to be used, using the rule descriptors of the plurality of rule descriptors of the policy rule data object that are determined to satisfy the one or more first conditions and using one or more of the parameters of the rule descriptors of the plurality of rule descriptors of the policy rule data object that are determined to satisfy the one or more first conditions that satisfy the one or more second conditions.

2. The apparatus of claim 1, wherein the policy rule data object is received subsequent to transmission, by the apparatus, of a compatibility support indication.

3. The apparatus of claim 1, wherein in an instance in which at least one respective parameter of the plurality of parameters of the respective rule descriptor is associated with a respective network applicability indication that has a first network applicability indication value, determining that the respective rule descriptor does not satisfy the one or more first conditions.

4. The apparatus of claim 1, wherein the identifying comprises identifying a respective parameter of the plurality of parameters of the respective rule descriptor as not satisfying the one or more second conditions in an instance in which the respective parameter is associated with a respective network applicability indication that has a second network applicability indication value and identifying the respective parameter as satisfying the one or more second conditions in an instance in which the respective parameter is associated with a respective network applicability indication that has a third network applicability indication that has a third value.

5. The apparatus of claim 1, wherein the at instructions of the computer program code when executed by the at least one processor, cause the apparatus to perform receiving a second policy rule data object comprising a plurality of rule descriptors and one or more higher-precedence rule descriptors corresponding to one or more of the plurality of rule descriptors comprised in the policy rule data object.

6. The apparatus of claim 5, wherein the one or more of the plurality of rule descriptors of the second policy rule comprise at least one of a pre-determined set of non-applicable parameters.

7. The apparatus of claim 1, wherein the plurality of parameters of the rule descriptor of the policy rule data object define a network connection with a native network, and wherein the network applicability indication associated with a respective parameter of the plurality of parameters describes at least one of: an applicability of the rule descriptor; or the respective parameter to the non-native network.

8. The apparatus of claim 7, wherein the network connection that is caused to be established or that is caused to be used is with the non-native network.

9. The apparatus of claim 1, wherein at least a first parameter of the plurality of parameters associated with the respective network applicability indications describes one or more locations at which the apparatus is enabled to establish and/or use a network connection and at least a second parameter of the plurality of parameters associated with the respective network applicability indications describes a time window within which the apparatus is enabled to at least: establish a network connection; or use the network connection.

10. The apparatus of claim 1, wherein the plurality of rule descriptors comprises at least a first rule descriptor that is a traffic descriptor and one or more second rule descriptors that are route selection descriptors.

11. The apparatus of claim 1, wherein the subset of the plurality of rule descriptors comprises one or more route selection descriptors that are determined to independently satisfy the one or more first conditions.

12. The apparatus of claim 1, wherein the policy rule data object is received over a native network, and wherein the non-native network is different from the native network.

13. The apparatus of claim 12, wherein the native network comprises a 5^{th}-Generation System (5GS), and wherein the non-native network comprises an Evolved Packet System (EPS).

14. An apparatus comprising:
at least one processor; and
at least one memory including computer program code,
the computer program code comprising instructions which, when executed by the at least one processor, cause the apparatus at least to perform:
receiving a compatibility support indication associated with a user equipment (UE);
for a policy rule data object comprising a plurality of rule descriptors, wherein each respective rule descriptor of the plurality of rule descriptors comprises a plurality of parameters, generating a network applicability indication for each respective parameter of the plurality of parameters comprised in each respective rule descriptor based at least on the computability support indication;
transmitting the policy rule data objects and the network applicability indication for each respective parameter of the plurality of parameters to the UE; and
receiving an acknowledgement of receipt of the policy rule data object from the UE.

15. The apparatus of claim 14, wherein the generating the network applicability indication for each respective parameter of each respective rule descriptor comprises:
determining at least one of: an applicability of the respective rule descriptor; or the respective parameter to a non-native network for the UE, the respective parameter defining a network connection with a native network for the UE, and
assigning one of a first network applicability indication value, a second network applicability indication value, or a third network applicability indication value to the respective network applicability indication based at least on the applicability.

16. The apparatus of claim 15, wherein the native network for the UE comprises a 5th Generation System (5GS), and wherein the non-native network comprises an Evolved Packet System (EPS).

17. The apparatus of claim 15, wherein the first network applicability indication value is configured to cause the respective rule descriptor comprising the respective parameter associated with the respective network applicability indication that has the first network applicability indication value to not satisfy one or more first conditions, the second network applicability indication value is configured to cause the respective parameter associated with the respective network applicability indication that has the second network applicability indication value to not satisfy one or more second conditions, and the third network applicability indication value is configured to cause the respective parameter associated with the respective network applicability indication that has the third network applicability indication value to satisfy the one or more second conditions.

18. The apparatus of claim 14, wherein the instructions of the computer program code when executed by the at least one processor, cause the apparatus to perform:
responsive to the compatibility support indication indicating that the UE is not configured for a non-native network:
identifying one or more of the plurality of rule descriptors that comprise at least one of a pre-determined set of non-applicable parameters, and
generating a higher-precedence rule descriptor corresponding to respective rule descriptors of the one or more rule descriptors.

19. The apparatus of claim 14, wherein at least a first parameter of the plurality of parameters associated with a respective network applicability indication describes at least one of: one or more locations at which the UE is enabled to establish; or use a network connection and at least a second parameter of the plurality of parameters associated with a respective network applicability indication describes a time window within which the UE is enabled to at least one of: establish a network connection or use the network connection.

20. The apparatus of claim 14, wherein the plurality of rule descriptors comprises a traffic descriptor and one or more route selection descriptors.

21. The apparatus of claim 14, wherein the plurality of rule descriptors are configured to be independently evaluated by the UE as to whether one or more first conditions are satisfied.

22. The apparatus of claim 14, wherein the apparatus is a network device of a native network for the UE, and the transmission of the one or more policy rule data objects to the UE is over the native network for the UE.

23-88. (canceled)
